(19) United States
(12) Patent Application Publication
(10) Pub. No.: US 2004/0183944 A1
(43) Pub. Date: Sep. 23, 2004

(54) Cathode ray tube device and deflection yoke

(76) Inventors: Kiyoshi Aoki, Tokyo (JP); Yoshihito Matsuura, Tokyo (JP); Hiroaki Nishino, Tokyo (JP); Junichi Igarashi, Tokyo (JP)

Correspondence Address: BIRCH STEWART KOLASCH & BIRCH, PO BOX 747, FALLS CHURCH, VA, 22040-0747, US

(21) Appl. No.: 10/725,465

(22) Filed: Dec. 3, 2003

(30) Foreign Application Priority Data
Mar. 19, 2003 (JP) 2003-074755

(51) Int. Cl. H04N 5/68

(52) U.S. Cl. 348/380

(57) ABSTRACT

A cathode ray tube device has a vacuum envelope including a panel, a funnel and a neck. A deflection yoke is mounted to a yoke-mounting portion of the funnel. The deflection coil includes a horizontal deflection coil, a vertical deflection coil, a separator provided between the coils, and a hollow core surrounding the coils. The sectional shape of at least an outer surface of the hollow core varies from a circular shape to a substantially barrel shape, along the tube axis from the neck side to the panel side. The substantially barrel shape has a maximum dimension at least in a direction of the horizontal axis or the vertical axis.

### BACKGROUND OF THE INVENTION

1. Field of the Invention

This invention relates to a cathode ray tube device employed in a television, a display device of a computer or the like, and relates to a deflection yoke used in the cathode ray tube device for deflecting electron beams along horizontal and vertical axes.

2. Description of the Related Art

A cathode ray tube device employed in a television, a display device of a computer or the like has an electron gun that emits electron beams and a deflection yoke that deflects the electron beams along horizontal and vertical axes. The deflection yoke includes horizontal and vertical deflection coils mounted on an outer surface of a narrow part of a funnel, and a hollow core that surrounds at least one of the deflection coils. Recently, the cathode ray tube device has a relatively high deflection frequency, and therefore a deflection power consumption (i.e., an electrical power consumed by the deflection yoke) increases. In order to reduce the deflection power consumption, a recently proposed cathode ray tube device has a structure in which the sectional shape of the narrow part of the funnel gradually varies from a circular shape to a rectangular shape, along the tube axis from the neck side to the panel side of the funnel. Such a cathode ray tube device is disclosed in Japanese Laid-Open Patent Publication Nos. HEI 11-265666, 2000-294165, and 2001-135260.

According to the above-described conventional cathode ray tube device, the collision of the electron beams with the inner surface of the funnel can be prevented. Further, the horizontal and vertical deflection coils can be located proximately to a region through which the electron beams pass (hereinafter, referred to as a beam passage region), and therefore the deflection power consumption can be reduced.

However, when the funnel of the above-described cathode ray tube device is evacuated, side walls of the rectangular-shaped portion of the funnel may deform inwardly, so that a crack may be formed at the corner of the rectangular-shaped portion. Thus, the resistance of the funnel to atmospheric pressure decreases. In order to prevent the generation of the crack, the narrow part of the funnel needs to be rounded as a whole. However, if the narrow part of the funnel is rounded, the deflection yoke can not be located proximately to the beam passage region in the funnel, so that the deflection power consumption can not be reduced.

It is possible to reduce the cross sectional area of the narrow part of the funnel in order to reduce the deflection power consumption. However, if the cross sectional area of the narrow part of the funnel is reduced, a so-called BSN (Beam Strike Neck) phenomenon may occur. The BSN phenomenon is a phenomenon where the electron beams directed to the corner of the screen collide with the inner surface of the narrow part of the funnel, so that the quality of the image is degraded.

Furthermore, a general cathode ray tube device has an inner conductive film formed on the inner surface of the funnel for keeping constant the electrical potential of the interior of the cathode ray tube device. The inner conductive film is formed by applying a graphite slurry to the inner surface of the funnel while the funnel is rotated in such a manner that the graphite slurry flows from the panel side toward the neck side of the funnel. This method is called a flow-coat. If the narrow part of the funnel has the rectangular-shaped portion as described above, a part of the slurry accumulates at the corner of the rectangular-shaped portion, so that the coating may become uneven. In such a case, after the slurry is dried (i.e., after the inner conductive film is formed), a part of the inner conductive film may flake off and may adhere to a color selection electrode.

Additionally, the general cathode ray tube device has a getter for ensuring a vacuum in the cathode ray tube device. The getter is mounted on a tip of a strip-shaped getter supporting member disposed along the inner surface of the funnel. Thus, if the narrow part of the funnel has a rectangular-shaped portion, there is little space outside the beam passage region in the narrow part of the funnel. As a result, the getter supporting member must be located in the proximity of the beam passage region, and therefore a shadow of the getter supporting member may appear on the screen, i.e., the convergence on the lower part of the screen may decrease.

### SUMMARY OF THE INVENTION

An object of the present invention is to provide a cathode ray tube device capable of improving the resistance to atmospheric pressure, reducing a deflection power consumption, improving the quality of an image, and simplifying the installation of a getter and the formation of an inner conductive film.

According to the invention, there is provided a cathode ray tube device including a vacuum envelope. The vacuum envelope includes a funnel-shaped portion having a tube axis, a panel connected to one end of the funnel-shaped portion in the direction of the tube axis, and a substantially cylindrical neck connected to an opposite end of the funnel-shaped portion. The panel has a substantially rectangular screen on which horizontal and vertical axes are defined. The funnel-shaped portion includes a yoke-mounting portion adjacent to the neck.

The cathode ray tube device further includes an electron gun mounted in the neck, and a deflection yoke mounted on an outer surface of the yoke-mounting portion. The electron gun emits electron beams. The deflection yoke includes horizontal and vertical deflection coils for deflecting the electron beams along the horizontal and vertical axes. The deflection yoke further includes a separator provided between the horizontal and vertical deflection coils, and a hollow core with high magnetic permeability surrounding at least one of the horizontal and vertical deflection coils.

The hollow core has outer and inner surfaces, and a sectional shape of at least the outer surface, in a plane perpendicular to the tube axis, varies from a substantially circular shape to a substantially barrel shape, along the tube axis from the neck side to the panel side of the hollow core. The substantially barrel shape has a maximum dimension at least in a direction of the horizontal axis or the vertical axis. The yoke-mounting portion has outer and inner surfaces, and a sectional shape of at least the outer surface, in a plane perpendicular to the tube axis, varies from a substantially circular shape to a substantially barrel shape, along the tube axis from the neck side to the panel side of the yoke-mounting portion. The substantially barrel shape has a maximum dimension at least in the above described direction.

With such an arrangement, the resistance to atmospheric pressure can be improved, and the deflection power consumption can be reduced. Further, the degradation of the image can be prevented. Additionally, the inner conductive film can be easily formed in the funnel-shaped portion, and the sufficient space can be provided in the funnel-shaped portion for mounting the getter supporting member.

### BRIEF DESCRIPTION OF THE DRAWINGS

In the attached drawings:

FIG. 1 is a perspective view of a cathode ray tube device according to Embodiment 1 of the present invention;

FIG. 2 is a sectional view of the cathode ray tube device according to Embodiment 1;

FIG. 3 is a sectional view of a deflection yoke and a yoke-mounting portion of the cathode ray tube device according to Embodiment 1;

FIGS. 4A and 4B are perspective views of a hollow core and a horizontal deflection coil of the deflection yoke of the cathode ray tube device according to Embodiment 1;

FIG. 5 is a sectional view illustrating one fourth of the sectional shape of the yoke-mounting portion of the cathode ray tube device according to Embodiment 1;

FIG. 6 is a sectional view illustrating a comparative example as opposed to the cathode ray tube device according to Embodiment 1;

FIG. 7 is a perspective view of a cathode ray tube device according to Embodiment 2 of the present invention;

FIGS. 8A and 8B are perspective views of a hollow core and a horizontal deflection coil of a deflection yoke of the cathode ray tube device according to Embodiment 2; and

FIG. 9 is a sectional view illustrating one fourth of the sectional shape of the yoke-mounting portion of the cathode ray tube device according to Embodiment 2.

### DETAILED DESCRIPTION OF THE INVENTION

Embodiments of the present invention will be described with reference to the attached drawings.

Embodiment 1.

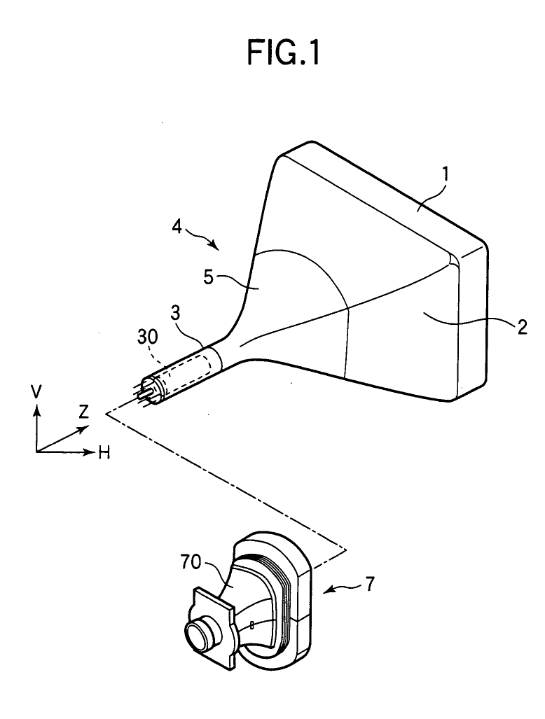

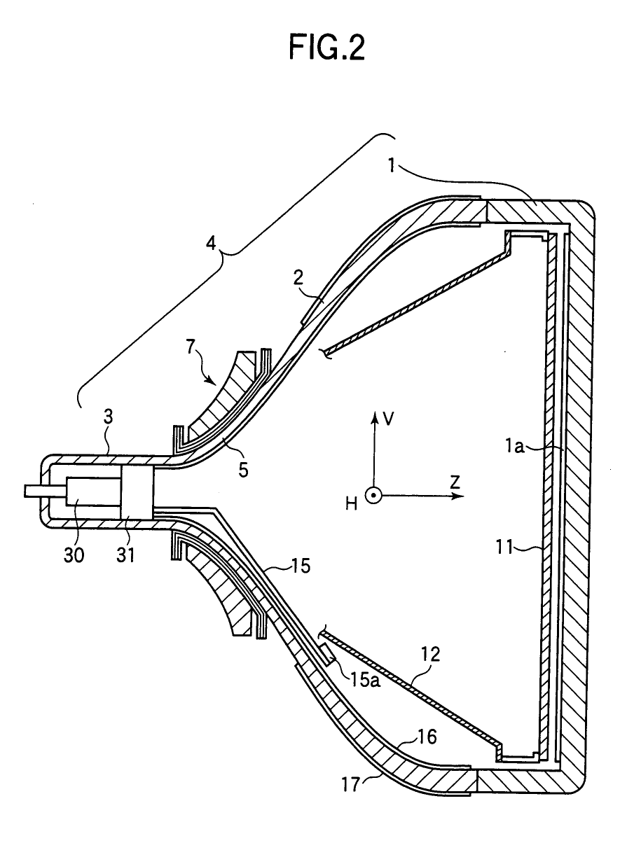

FIGS. 1 and 2 are a perspective view and a sectional view of a cathode ray tube device according to Embodiment 1. As shown in FIG. 1, the cathode ray tube device according to Embodiment 1 includes a vacuum envelope 4, a deflection yoke 7 and an electron gun 30. The vacuum envelope 4 includes a funnel 2 (i.e., a substantially funnel-shaped portion) in which a tube axis (Z-axis) is defined. The vacuum envelope 4 further includes a rectangular panel 1 connected to an end of the funnel 2 in the direction of Z-axis, and a cylindrical neck 3 connected to the other end of the funnel 2 in the direction of Z-axis. The funnel 2 has a yoke-mounting portion 5 adjacent to the neck 3. The deflection yoke 7 is mounted on the outer surface of the yoke-mounting portion 5 of the funnel 2. Hereinafter, the panel 1 side of the funnel 2 is referred to as “front”, and the neck 3 side of the funnel 2 is referred to as “rear”.

As shown in FIG. 2, a screen 1a is formed on the inner surface of the panel 1. The screen 1a has phosphor layers emitting blue, green and red light. The screen 1a has a rectangular shape. The horizontal (H) axis is defined as an axis in parallel with long sides of the screen 1a. The vertical (V) axis is defined as an axis in parallel with short sides of the screen 1a. The ratio (i.e., an aspect ratio) of the dimension M of the screen 1a along H-axis to the dimension N of the screen 1a along V-axis (M:N) is 4:3 or 16:9.

A shadow mask 11 (i.e., a color selection electrode) is disposed inside the panel 1 in such a manner that the shadow mask 11 faces the screen 1a of the panel 1. An inner magnetic shield 12 is fixed to the shadow mask 11. An electron gun unit 31 including the electron gun 30 is provided in the neck 3. The electron gun 30 is of a so-called in-line type having three beam emitting portions arranged in the direction of H-axis.

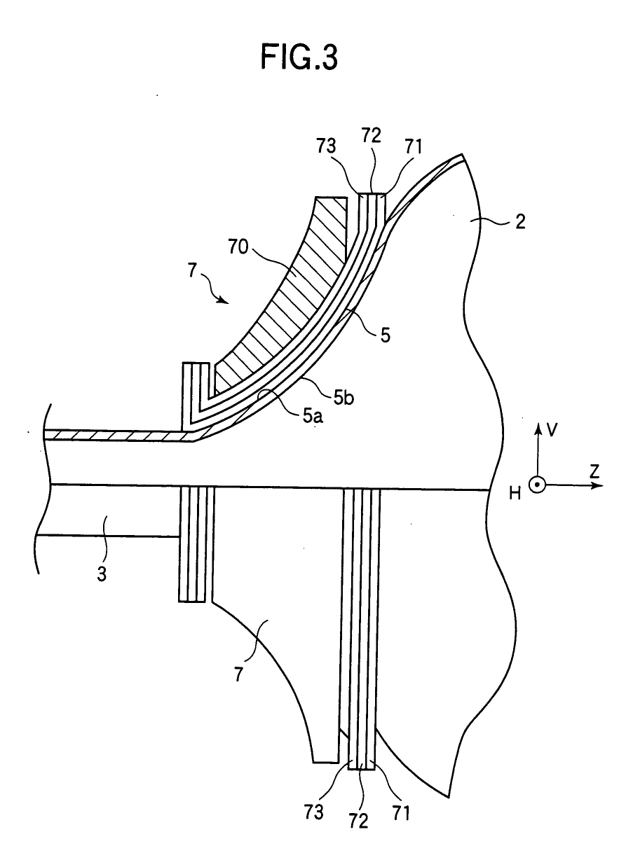

FIG. 3 is an enlarged sectional view illustrating the deflection yoke 7 and the yoke-mounting portion 5 of the funnel 2. The deflection yoke 7 includes a horizontal deflection coil 71 wound around the outer surface of the yoke-mounting portion 5 of the funnel 2, a separator 72 surrounding the horizontal deflection coil 71, and a vertical deflection coil 73 wound around the separator 72. A hollow core 70 surrounds the deflection coils 71 and 73 and the separator 72. The horizontal deflection coil 71 generates horizontal deflection magnetic field for deflecting the electron beams along H-axis. The vertical deflection coil 73 generates vertical deflection magnetic field for deflecting the electron beams along V-axis. The separator 72 is a funnel-shaped member made of synthetic resin, and is provided for separating the horizontal and vertical deflection coils 71 and 73 from each other. The hollow core 70 has high magnetic permeability, and constitutes a magnetic core or a return magnetic path for the deflection magnetic field.

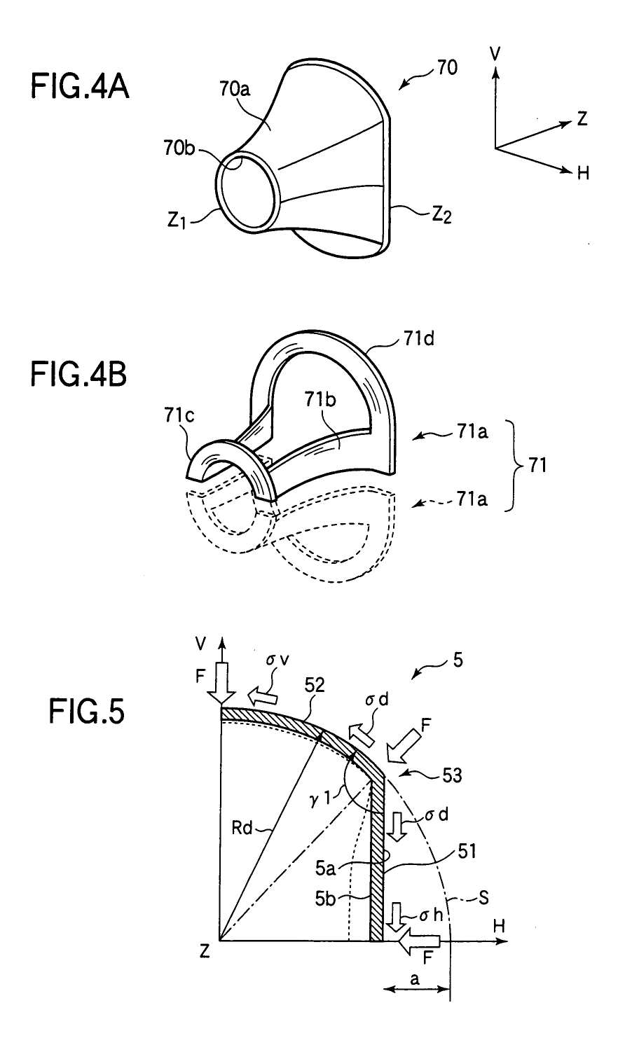

FIG. 4A is a perspective view of the hollow core 70 of the deflection yoke 7. FIG. 4B is a perspective view of the horizontal deflection coil 71 of the deflection yoke 7. As shown in FIG. 4B, the horizontal deflection yoke 71 includes a pair of vertically opposed coil portions 71a each of which is wound in the form of a saddle. Each coil portion 71a includes a pair of extending portions 71b. The extending portions 71b are laterally opposed to each other, and extend along the outer surface of the yoke-mounting portion 5 (FIG. 3) in substantially front-rear direction. Each coil portion 71a further includes a bridge portion 71c that connects rear ends of the extending portions 71b, and another bridge portion 71d that connects front ends of the extending portions 71b. The vertical deflection coil 73 (FIG. 3) is wound around the horizontal deflection coil 71 in the form of a saddle so that the separator 72 (FIG. 3) is provided between the horizontal and vertical deflection coils 71 and 73. Because of the separator 72, the horizontal and vertical deflection coils 71 and 73 do not contact each other.

The deflection yoke in which the horizontal and vertical deflection coils 71 and 73 are wound in the forms of the saddles is called a “saddle-saddle” type. The deflection yoke of this type has an advantage that the leakage of the magnetic field can be restricted. However, this Embodiment is adaptable to a deflection yoke of a “saddle-toroidal” type in which the horizontal deflection coil 71 is wound in the form of the saddle and the vertical deflection coil 73 is wound in a toroidal shape. In the deflection yoke of this type, the hollow core 70 acts as a magnetic core around which a toroidal coil (i.e., the vertical deflection yoke 73) is wound.

The hollow core 70 surrounds the horizontal deflection coil 71, the separator 72 (FIG. 3) and the vertical deflection coil 73 (FIG. 3). As shown in FIG. 4A, the sectional shape of the hollow core 70 in a plane perpendicular to Z-axis (hereinafter, simply referred to as the sectional shape) gradually varies from a circular shape to a substantially barrel shape, along Z-axis from the rear end position Z1 to the front end position Z2. The substantially barrel shape has the maximum dimension at least in the direction of V-axis.

To be more specific, the sectional shape of the outer surface 70a of the hollow core 70 varies from the circular shape to the substantially barrel shape (having the maximum dimension at least in the direction of V-axis), along Z-axis from the rear end position Z1 to the front end position Z2. The substantially barrel shape includes two straight sides that straightly extend along V-axis, and two arc-shaped sides that extend in the forms of circular arcs having the center of curvature aligned on Z-axis. Similarly, the sectional shape of the inner surface 70b of the hollow core 70 varies from the circular shape to the substantially barrel shape (having the maximum dimension at least in the direction of V-axis), along Z-axis from the rear end position Z1 to the front end position Z2.

FIG. 5 shows one fourth of the sectional shape of the yoke-mounting portion 5 in a plane at the front end position Z2. The sectional shape of the yoke-mounting portion 5 gradually varies from a circular shape to a substantially barrel shape (having the maximum dimension at least in the direction of V-axis), along Z-axis from the rear end position Z1 to the front end position Z2. Further, the substantially barrel shape includes two straight side walls that straightly extend along V-axis, and two arc-shaped side walls that extend in the forms of circular arcs having the center of curvature aligned on Z-axis. The angle γ1 of the corner 53 between the side walls 51 and 52 is obtuse.

To be more specific, the sectional shape of the outer surface 5a of the yoke-mounting portion 5 varies from the circular shape to the substantially barrel shape (having the maximum dimension at least in the direction of V-axis), along Z-axis from the rear end position Z1 to the front end position Z2. Further, the substantially barrel shape includes two straight sides that straightly extend along V-axis, and two arc-shaped sides that extend in the forms of circular arcs of radius Rd having the center of curvature aligned on Z-axis. Similarly, the sectional shape of the inner surface 5b of the yoke-mounting portion 5 varies from the circular shape to the substantially barrel shape (having the maximum dimension at least in the direction of V-axis), along Z-axis from the rear end position Z1 to the front end position Z2.

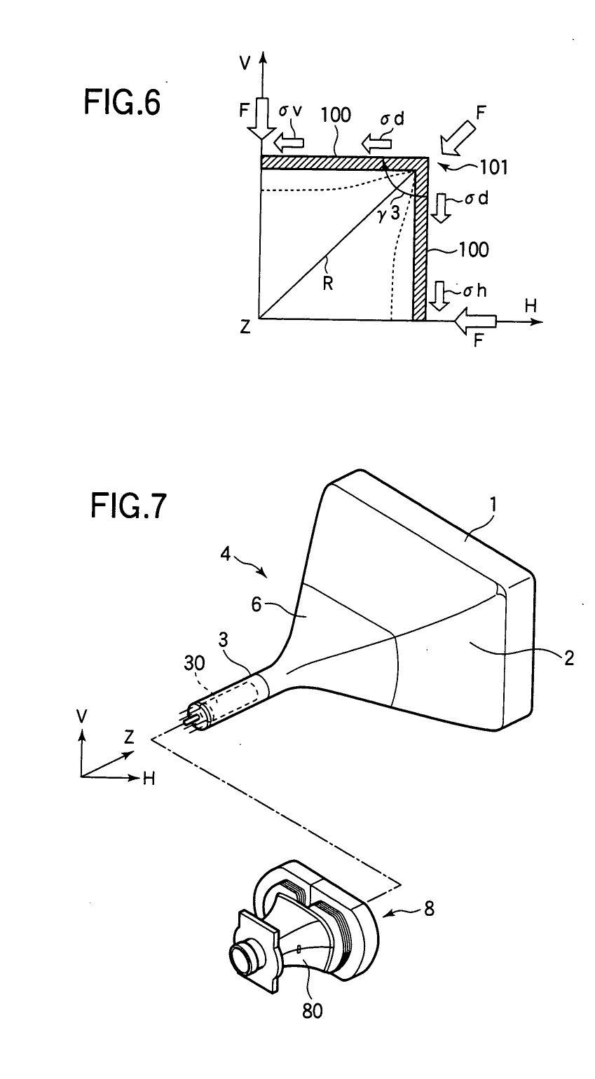

FIG. 6 shows one fourth of the sectional shape of a conventional yoke-mounting portion as opposed to the yoke-mounting portion of Embodiment 1. The sectional shape of the conventional yoke-mounting portion shown in FIG. 6 is rectangular, and therefore side walls 100 may deform inwardly by atmospheric pressure F when the vacuum envelope is evacuated, so that compressive stresses h and v are generated on the outer surfaces of the side walls 100. When the side walls 100 deform inwardly, the angle γ3 of a corner 101 becomes acute, so that a large tension-stress d is applied to the outer surface of the corner 101, and therefore a crack may easily be generated at the corner 101.

In contrast, in the yoke-mounting portion 5 of Embodiment 1, the angle γ1 of the corner 53 is obtuse as shown in FIG. 5. Thus, even if the side walls 51 and 52 deform inwardly by the atmospheric pressure F as indicate by a dashed line when the vacuum envelope is evacuated, the generation of a large tension-stress d on the outer surface of the corner 53 can be prevented. Further, the arc-shaped side wall 52 takes the form of the circular arc having the center of curvature aligned on Z-axis, and therefore the deformation of the arc-shaped side wall 52 caused by the atmospheric pressure F can be restricted to a small amount. As a result, it is possible to prevent the generation of the crack at the corner 53, so that the resistance to the atmospheric pressure can be improved.

Moreover, as shown in FIG. 4A, the sectional shape of the hollow core 70 varies from the circular shape to the substantially barrel shape (having the maximum dimension at least in V-axis), along Z-axis from the rear end position Z1 to the front end position Z2, and therefore the deflection yoke 7 can be located proximately to the beam passage region in the direction along H-axis. As a result, the deflection magnetic field acts efficiently on the electron beam, and therefore the deflection power consumption can be reduced.

There is an additional effect of the Embodiment 1 regarding the provision of a getter and an inner conductive film. A getter material (not shown) is set in the funnel 2 and is evaporated by high-frequency heating during manufacture of the cathode ray tube device. The getter is mounted on a getter supporting member 15 provided in the interior of the funnel 2 as shown in FIG. 2. The getter supporting member 15 is a strip-shaped member, and extends along the inner surface of the funnel 2. A getter vessel 15a for holding the getter material is provided at one end of the getter supporting member 15, and the other end of the getter supporting member 15 is fixed to the electron gun unit 31 in the neck 3. Even after the getter material is evaporated in the manufacturing process of the cathode ray tube device, the getter supporting member 15 remains in the funnel 2.

According to Embodiment 1, the sectional shape of the inner surface 5b of the yoke-mounting portion 5 varies from the circular shape to the substantially barrel shape (having the maximum dimension at least in the direction of V-axis) as described above. Thus, there is a sufficient space for mounting the getter supporting member 15 on upper and lower sides of the beam passage region in the yoke-mounting portion 5. Therefore, the getter supporting member 15 can be mounted to a position sufficiently apart from the beam passage region, so that the shadow of the getter supporting member 15 does not appear on the screen 1a and the convergence is not degraded. As a result, it is not necessary to employ an alternative design in which the getter supporting member 15 is mounted on an anode (not shown) or the like, and therefore it is not necessary to change the manufacturing process or to reform the manufacturing line on a large scale.

Moreover, the inner conductive film 16 is formed in the inner surface of the funnel 2. The inner conductive film 16 is made of a graphite or the like, and has a function to keep constant the electric potential of the interior of the vacuum envelope 4. The inner conductive film 16 electrically connects a not-shown anode and a screen 1a, and connects the anode and an electrode of the electron gun 30. The inner conductive film 16 and an outer conductive film 17 formed on the outer surface of the funnel 2 constitute a capacitor that functions as a part of a driving circuit of a color television system. The inner conductive film 16 is formed by applying a graphite slurry to the inner surface of the funnel 2 while the funnel 2 is rotated, so that the graphite slurry flows from the front panel 1 side to the neck 3 side of the funnel 2. In the cathode ray tube device according to Embodiment 1, the angle of the corner 53 (FIG. 5) of the yoke-mounting portion 5 is obtuse, so that the accumulation of the graphite slurry at the corners 53 can be restricted. Thus, the coating of the graphite slurry becomes even. Therefore, after the slurry is dried, it is possible to prevent the inner conductive film 16 from flaking off, and to prevent the flakes from adhering to the shadow mask 11.

As described above, according to the cathode ray tube device of Embodiment 1, it is possible to improve the resistance to the atmospheric pressure, and to reduce the deflection power consumption. In addition, it is possible to prevent the electron beams from colliding with the inner surface of the yoke-mounting portion 5, so that the quality of the image can be improved. Further, it is possible to prevent the shadow of the getter supporting member 15 from appearing on the screen 1a, and to simplify the formation of the inner conductive film 16.

In the above description, each of the outer surface 70a and the inner surface 70b of the hollow core 70 varies from the circular shape to the substantially barrel shape, along Z-axis from the rear end position Z1 to the front end position Z2. However, it is possible that only the outer surface 70a of the hollow core 70 varies from the circular shape to the substantially barrel shape, along Z-axis from the rear end position Z1 to the front end position Z2. Similarly, in the above description, each of the outer surface 5a and the inner surface 5b of the yoke-mounting portion 5 varies from the circular shape to the substantially barrel shape, along Z-axis from the rear end position Z1 to the front end position Z2. However, it is possible that only the outer surface 5a of the yoke-mounting portion 5 varies from the circular shape to the substantially barrel shape, along Z-axis from the rear end position Z1 to the front end position Z2.

Embodiment 2.

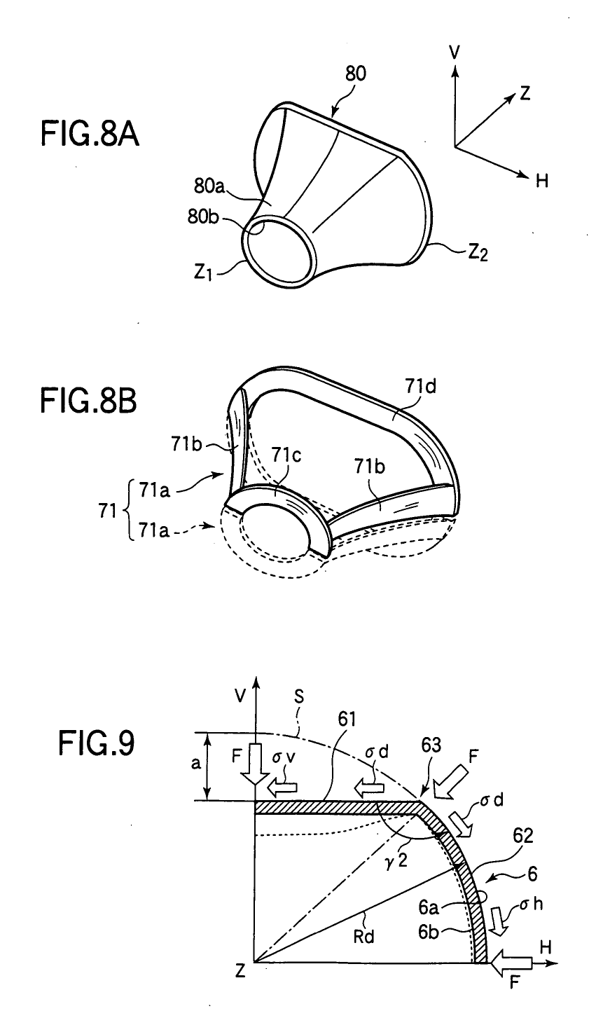

FIG. 7 is a perspective view of a cathode ray tube device according to Embodiment 2. FIGS. 8A and 8B are perspective views of the hollow core 80 and the horizontal deflection coil 71 of the deflection yoke 8 (FIG. 7) of the cathode ray tube device according to Embodiment 2.

As shown in FIG. 8A, the sectional shape of the hollow core 80 gradually varies from the circular shape to the substantially barrel shape (having the maximum dimension at least in the direction of H-axis), along Z-axis from the rear end position Z1 to the front end position Z2.

To be more specific, the sectional shape of the outer surface 80a of the hollow core 80 gradually varies from the circular shape to the substantially barrel shape (having the maximum dimension at least in the direction of H-axis), along Z-axis from the rear end position Z1 to the front end position Z2. Further, the substantially barrel shape includes two straight sides extending along H-axis, and two arc-shaped sides extending in the forms of circular arcs having the center of curvature aligned on Z-axis. Similarly, the sectional shape of the inner surface 80b of the hollow core 80 gradually varies from the circular shape to the substantially barrel shape (having the maximum dimension at least in the direction of H-axis), along Z-axis from the rear end position Z1 to the front end position Z2.

As shown in FIG. 8B, the horizontal deflection yoke 71 includes two coil portions 71a. Each coil portion 71a includes a pair of extending portions 71b. The extending portions 71b are laterally opposed to each other, and extend along the outer surface of the yoke-mounting portion 6 (FIG. 7) of the funnel in substantially front-rear direction. Each coil portion 71a further includes a bridge portion 71c that connects rear ends of the extending portions 71b, and another bridge portion 71d that connects front ends of the extending portions 71b. As was described in Embodiment 1, the horizontal deflection coil 71 is wound around the yoke-mounting portion 6, and is surrounded by the separator 72 (FIG. 3). The vertical deflection coil 73 (FIG. 3) is wound around the separator 72. The horizontal deflection yoke 71, the separator 72 and the vertical deflection yoke 73 are surrounded by the hollow core 80.

FIG. 9 shows one fourth of the sectional shape of the yoke-mounting portion 6 at the front end position Z2. The sectional shape of the yoke-mounting portion 6 gradually varies from the circular shape to the substantially barrel shape (having the maximum dimension at least in the direction of H-axis), along Z-axis from the rear end position Z1 to the front end position Z2. The substantially barrel shape includes two straight side walls 61 extending along H-axis and two arc-shaped side walls 62 having the center aligned on Z-axis. The angle γ2 of the corner 63 between the side walls 61 and 62 is obtuse.

To be more specific, the sectional shape of the outer surface 6a of the yoke-mounting portion 6 varies from the circular shape to the substantially barrel shape (having the maximum dimension at least in the direction of H-axis), along Z-axis from the rear end position Z1 to the front end position Z2. The substantially barrel shape includes two straight sides that straightly extend along H-axis, and two arc-shaped sides that extend in the form of circular arcs having the radius Rd and having the center of curvature aligned on Z-axis. Similarly, the sectional shape of the inner surface 6b of the yoke-mounting portion 6 varies from the circular shape to the substantially barrel shape (having the maximum dimension at least in the direction of H-axis), along Z-axis from the rear end position Z1 to the front end position Z2.

In the yoke-mounting portion 6 of Embodiment 2, the angle γ2 of the corner 63 is obtuse as shown in FIG. 9. Thus, even if the side walls 61 and 62 deform inwardly by the atmospheric pressure F as indicate by a dashed line when the vacuum envelope is evacuated, the generation of a large tension-stress d on the outer surface of the corner 63 can be prevented. Further, the side wall 62 is in the form of the circular arc having the center aligned on Z-axis, and therefore the deformation of the side wall 62 caused by the atmospheric pressure F can be restricted to a small amount. As a result, it is possible to restrict the generation of the crack on the corner 63, so that the resistance to the atmospheric pressure can be improved.

Further, as is also seen from FIG. 8A, the sectional shape of the hollow core 80 varies from the circular shape to the substantially barrel shape (having the maximum dimension at least in the direction along H-axis), along Z-axis from the rear end position Z1 to the front end position Z2, and therefore the horizontal deflection coil 71 and the vertical deflection coil 73 (FIG. 3) can be located proximately to the beam passage region in the direction along V-axis. As a result, the deflection magnetic field acts efficiently on the electron beam, and therefore the deflection power consumption can be reduced.

Moreover, there is a sufficient space for providing the getter supporting member 15 (FIG. 2) on the left and right sides of the beam passage region inside the yoke-mounting portion 6. Thus, the getter supporting member 15 can be mounted to a position sufficiently apart from the beam passage region so that the shadow of the getter supporting member 15 does not appear on the screen 1a and that the convergence is not degraded. Furthermore, the accumulation of the graphite slurry at the corners 63 can be restricted, and therefore the coating becomes even. Thus, it is possible to prevent the inner conductive film 16 from flaking off.

As described above, according to the cathode ray tube device of Embodiment 2, it is possible to improve the resistance to the atmospheric pressure, and to reduce the deflection power consumption. In addition, it is possible to prevent the electron beams from colliding with the inner surface of the yoke-mounting portion 6, so that the quality of the image can be improved. Further, it is possible to prevent the shadow of the getter supporting member 15 from appearing on the screen 1a, and to simplify the formation of the inner conductive film 16.

As was described in Embodiment 1, it is possible that only the outer surface 80a of the hollow core 80 varies from the circular shape to the substantially barrel shape, along Z-axis from the rear end position Z1 to the front end position Z2. Similarly, it is possible that only the outer surface 6a of the yoke-mounting portion 6 varies from the circular shape to the substantially barrel shape, along Z-axis from the rear end position Z1 to the front end position Z2.

Next, the numerical analysis for improving the deflection sensitivity and for preventing the BSN phenomenon will be described. The BSN phenomenon is a phenomenon where the electron beams collide with the inner surface of the yoke-mounting portion. In this numerical analysis, the structures of the yoke-mounting portions 5 and 6 are the same as those described in Embodiments 1 and 2.

With regard to the hollow core 70 according to Embodiment 1, distances Yhc and Yvc are defined in a plane perpendicular to Z-axis at an arbitrary position other than the proximity of the rear end position Z1. The distance Yhc represents the distance from Z-axis to the outer surface 70a of the hollow core 70 in the direction of H-axis. The distance Yvc represents the distance from Z-axis to the outer surface 70a of the hollow core 70 in the direction of V-axis. Further, as described above, the aspect ratio of the screen 1a (i.e., the ratio of the dimension along H-axis to the dimension along V-axis) is expressed as M:N. The optimum relationship between these distances Yhc and Yvc and the aspect ratio M:N is determined by a deflection-magnetic-field simulation analysis in which the trajectory of the electron beams emitted by the electron gun 30 and the magnetic field generated by the deflection yoke 7 are analyzed.

With regard to the hollow core 80 according to Embodiment 2, distances Yhc and Yvc are defined in a plane perpendicular to Z-axis at an arbitrary position other than the proximity of the rear end position Z1. The distance Yhc represents the distance from Z-axis to the outer surface 80a of the hollow core 80 in the direction of H-axis. The distance Yvc represents the distance from Z-axis to the outer surface 80a of the hollow core 80 in the direction of V-axis. Further, the aspect ratio of the screen 1a is expressed as M:N. The optimum relationship between these distances Yhc and Yvc and the aspect ratio M:N is determined by the above described simulation analysis.

As a result of the analysis, the optimum relationship (1) is obtained for improving the deflection sensitivity and preventing the BSN phenomenon in the cathode ray tube device according to Embodiment 1 (where Yhc<Yvc). Further, the optimum relationship (2) is obtained for improving the deflection sensitivity and preventing the BSN phenomenon in the cathode ray tube device according to Embodiment 2 (where Yhc>Yvc).

0.6×(N/M)(Yvc²−Yhc²)^{1/2}/Yhc1.2×(N/M) (1)

1.2×(N/M)Yvc/(Yhc²−Yvc²)^{1/2}1.8×(N/M) (2)

The initial condition of the above described analysis will be described. The horizontal deflection magnetic field is in the shape of a pincushion, and the vertical deflection magnetic field is in the shape of a barrel. Further, the center of the vertical deflection magnetic field is positioned closer to the neck 3 than the center of the horizontal deflection magnetic field is. Thus, the electron beam directed to the corner of the screen 1a is initially deflected strongly in the direction of V-axis, and then deflected gradually in the directions of H-axis and V-axis. Therefore, the aspect ratio of the beam passage region in the funnel 2 is different from the aspect ratio of the screen 1a. Thus, the following relationship (3) is used as the initial condition of the analysis when the distance Yhc is smaller than the distance Yv. Similarly, the following relationship (4) is used as the initial condition of the analysis when the distance Yhc is greater than the distance Yvc.

N/M≠(Yvc²−Yhc²)^{1/2}/Yhc (3)

N/MYv/(Yhc²−Yvc²)^{1/2} (4)

As described above, when the outer surface 70a of the hollow core 70 satisfies the relationship (1), and when the outer surface 80a of the hollow core 80 satisfies the relationship (2), the deflection sensitivity can be improved and therefore the deflection power consumption can be reduced. In addition, the collision of the electron beams with the inner surface of the yoke-mounting portions 5 and 6 can be prevented, and therefore the degradation of the image can be prevented.

While the preferred embodiments of the present invention have been illustrated in detail, it should be apparent that modifications and improvements may be made to the invention without departing from the spirit and scope of the invention as described in the following claims.

What is claimed is:—

1. A cathode ray tube device comprising:
a vacuum envelope including a substantially funnel-shaped portion having a tube axis, a panel connected to one end of said funnel-shaped portion in a direction of said tube axis, a substantially cylindrical neck connected to an opposite end of said funnel-shaped portion, said panel including a substantially rectangular screen on which horizontal and vertical axes are defined, said funnel-shaped portion including a yoke-mounting portion adjacent to said neck;
an electron gun mounted in said neck, said electron gun emitting electron beams; and
a deflection yoke mounted on an outer surface of said yoke-mounting portion, said deflection yoke including a horizontal and vertical deflection coils for deflecting said electron beams along horizontal and vertical axes, a separator provided between said horizontal and vertical deflection coils, and a hollow core with high magnetic permeability surrounding at least one of said horizontal and vertical deflection coils,
wherein said hollow core has outer and inner surfaces, and a sectional shape of at least said outer surface, in a plane perpendicular to said tube axis, varies from a substantially circular shape to a substantially barrel shape, along said tube axis from said neck side to said panel side of said hollow core, said substantially barrel shape having a maximum dimension at least in a direction of said horizontal axis or said vertical axis,
wherein said yoke-mounting portion has outer and inner surfaces, and a sectional shape of at least said outer surface, in a plane perpendicular to said tube axis, varies from a substantially circular shape to a substantially barrel shape, along said tube axis from said neck side to said panel side of said yoke-mounting portion, said substantially barrel shape having a maximum dimension at least in said direction.

2. The cathode ray tube device according to claim 1, wherein said substantially barrel shape includes two substantially straight sides extending in parallel with said horizontal axis or said vertical axis, and two arc-shaped sides in the form of circular arcs having the center of curvature aligned on said tube axis.

3. The cathode ray tube device according to claim 1, wherein a sectional shape of at least said outer surface of said hollow core has maximum dimensions Yhc and Yvc respectively along said horizontal axis and said vertical axis, in a plane perpendicular to said tube axis at an arbitrary position other than the proximity of said neck, and
wherein said maximum dimensions Yhc and Yvc satisfy the following relationships (1) and (2):
0.6×(N/M)(Yvc²−Yhc²)^{1/2}/Yhc1.2×(N/M) (1)
when Yhc is smaller than Yvc
1.2×(N/M)Yvc/(YhC²−Yvc²)^{1/2}1.8×(N/M) (2)
when Yhc is greater than Yvc
where M and N respectively represent dimensions of said screen along said horizontal axis and said vertical axis.

4. A deflection yoke used in a cathode ray tube device, said cathode ray tube device comprising a vacuum envelope and an electron gun, said vacuum envelope including a funnel-shaped portion having a tube axis, a panel connected to one end of said funnel-shaped portion in the direction of said tube axis, and a substantially cylindrical neck connected to an opposite end of said funnel-shaped portion, said panel including a substantially rectangular screen on which horizontal and vertical axes are defined, said funnel-shaped portion having a yoke-mounting portion adjacent to said neck, said electron gun being mounted in said neck for emitting electron beams; said deflection yoke comprising:
horizontal and vertical deflection coils for deflecting said electron beams along said horizontal and vertical axes;
a separator provided between said horizontal and vertical deflection coils; and
a hollow core with high magnetic permeability surrounding at least one of said horizontal and vertical deflection coils,
wherein said hollow core has outer and inner surfaces, and a sectional shape of at least said outer surface, in a plane perpendicular to said tube axis, varies from a substantially circular shape to a substantially barrel shape, along said tube axis from said neck side to said panel side of said hollow core, said substantially barrel shape having a maximum dimension at least in a direction of said horizontal axis or said vertical axis.

5. The deflection yoke according to claim 4, wherein said substantially barrel shape includes two substantially straight sides extending in parallel with said horizontal axis or said vertical axis, and two arc-shaped sides in the form of circular arcs having the center of curvature aligned on said tube axis.

6. The deflection yoke according to claim 4, wherein a sectional shape of at least said outer surface of said hollow core has maximum dimensions Yhc and Yvc respectively along said horizontal axis and said vertical axis, in a plane perpendicular to said tube axis at an arbitrary position other than the proximity of said neck, and
wherein said maximum dimensions Yhc and Yvc satisfy the following relationships (1) and (2):
0.6×(N/M)(Yvc²−Yhc²)^{1/2}/Yhc1.2×(N/M) (1)
when Yhc is smaller than Yvc
1.2×(N/M)Yvc/(Yhc²−Yvc²)^{1/2}1.8×(N/M) (2)
when Yhc is greater than Yvc
where M and N respectively represent dimensions of said screen along said horizontal axis and said vertical axis.
